(19) United States
(12) Patent Application Publication
(10) Pub. No.: US 2003/0226886 A1
(43) Pub. Date: Dec. 11, 2003

(54) Business card information management system

(76) Inventor: Takashi Kakinuma, Tokyo (JP)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/325,586

(22) Filed: Dec. 19, 2002

(30) Foreign Application Priority Data
Jun. 10, 2002 (JP) JP2002-168675

(51) Int. Cl. G06F 17/00

(52) U.S. Cl. 235/375

(57) ABSTRACT

A business card information management system is disclosed having a business card user 3 that transmits business card information 20, stored in a business card user computer 5, to a server computer 9. Upon receipt of business card information 20, the server computer 9 prepares identifying information 27 of each business card 25. The identifying information 27 is transmitted to the business card user computer 5. This results in a capability of preparing a business card 25 displayed with identifying information 27. On the other hand, when a user who has received the business card 25 inputs identifying information 27 into the user computer 13, the user is able to acquire business card information 20, associated with identifying information 27, from the server computer 9.

### BACKGROUND OF THE INVENTION

1. Field of the Invention

The present invention relates to business card information management systems and, more particularly, a business card information management system that allows management of a business card and a roll of company employees utilizing an Internet.

2. Description of the Related Art

Attempts have been made to manage business cards in a physical method (for instance, a way of keeping business cards in a business card holder) to put the business cards in order or in an electronic fashion to put the business cards in order by inputting such information into a personal computer (for instance, by directly inputting business card information, such as names, names of companies, divisions/sections and titles or the like displayed in the business cards, respectively, through the use of an input means such as, a keyboard).

### SUMMARY OF THE INVENTION

It is conceivable for the physical management method of the business cards to include various other methods in addition to the methods set forth above and, in any case, these methods suffer from a difficulty in that the larger the number of business cards, the more serious will be the effort for management (such as storing and updating, etc.).

Further, when utilizing the management method with the personal computer, the management of inputted data is achieved in an easier way than that achieved in the above-described physical management method. However, if a large number of business cards exist, an issue arises in that a difficulty is encountered in inputting data into the personal computer. Also, when updating with addition of other business cards, another issue results in that new information must be additionally inputted.

In order to address the above issues encountered in the business card management systems set forth above, a first aspect of the present invention provides a business card information management system for managing business card information using identifying information incidental to each business card, comprising a business card user computer including preparing means for preparing the business card information and transmitting means for transmitting prepared business card information, a server computer including receiving means for receiving the business card information from the business card user computer, identifying information preparing means for preparing identifying information different for each received business card information, storing means for storing the identifying information in compliance with the business card information, transmitting information for transmitting the identifying information to the business card user computer, business card information storage means for storing a plurality of the business card information, and retrieving means for retrieving business card information, corresponding to the identifying information, from the storage means, and a user computer available to communicate at least the identifying information and the business card information via the server computer and a network, wherein when the user computer transmits the identifying information to the server computer via the network, the retrieving means transmits business card information, corresponding to the identifying information, to the user computer while allowing transmitted business card information to be displayed over display means of the user computer.

With the business card information management system of the first aspect described above, merely inputting identifying information allocated to each business card enables the business card to be available, providing an ease of achieving management of business card information that would otherwise be troublesome in the related art practice.

A second aspect of the present invention concerns to a business card information management system related to the first aspect, with the user computer featuring to include an interlocking means that is available to execute a function interlocking with business card information.

With the business card information management system of the second aspect, the presence of the interlocking means enables business card information to be merged with various functions, resulting in an improvement in convenience for a user of the present system.

### BRIEF DESCRIPTION OF THE DRAWINGS

FIG. 1 is a schematic diagram illustrating a business card information management system of an embodiment according to the present invention.

FIG. 2 is a flowchart illustrating a general routine of the business card information management system.

FIG. 3 is a flowchart that is contiguous with that of FIG. 2.

FIG. 4 is an illustrative representation of a screen of the business card information management system of the present invention.

FIG. 5 is an illustrative representation of another screen of the business card information management system of the present invention.

### DESCRIPTION OF PREFERRED EMBODIMENT

An embodiment of the present invention is described below in detail with reference to the accompanying drawings.

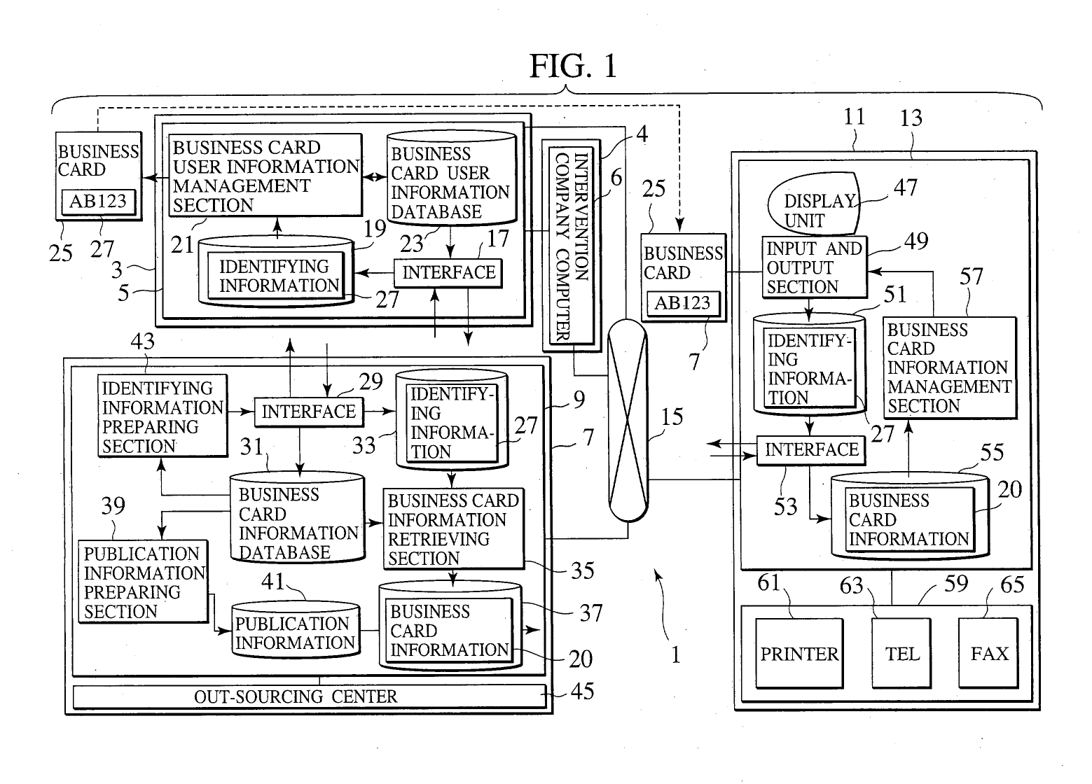

Referring to FIG. 1, a business card information management system 1 is comprised of a business card user computer 5 for use with a business card user 3, a user computer 13 that is used with a user 11 provided with a service of the system 1, a server computer 9 managed with a manager 7 of the present system 1, and a network 15 through which these computers are connected to one another.

The business card user 3 may involve a group of a public party, an enterpriser, a corporation such as a company or the like and an individual or the like. The presently filed embodiment is described hereinafter in supposition that the business card user 3 includes the company. The server computer 9 collects business card information (for instance, a name of the company, an address, a relevant division or section, a title, TEL, FAX and E-male address, etc.) of the business card user 3 to be provided to a third party (i.e., the user 11 in the present example). The user computer 13 includes the computer 13 that is used with the user 11 who achieves arrangement and management of business card information 20. Also, the business card user 3 may be connected to the network 15 via an intervening company (inclusive of a business card printing company and a roll publishing company, etc.) 4.

Further, the network 15 is comprised of The INTERNET or LAN, etc. that enable the business card user 5, the server computer 9 and the user computer 13 to mutually communicate with one another via the network 15.

Furthermore, when transmitting and receiving information to and from the server computer 9, the business card user 3 does not necessarily receive information in computer data and may obtain identifying information 27, which will be described in greater detail hereinafter, using other communication means (such as a mail, etc.) to use the identifying information 27 when preparing own business card.

The business card user computer 5 includes an interface 17 that executes transmission and reception of computer data (for instance, business card information 20, and identifying information 27 serving as data formed with a number or the like for identifying a person who has the business card 25), an identifying information memory 19 that stores identifying information 27 received via the interface 17, a business card user information management section 21 that is formed with software that manages business card information (such as a name of a company in employment, a relevant division or section, a title, an address, a number of TEL, a number of FAX and a family make-up, etc.) of each person (an individual) in employment with the business card user (for instance, the company), and business card information database 23 that preserves business card information 20 of the individual belonging to the business card user 3.

The individual belonging to the business card user 3 provides the own business card 25 with identifying information 27, which is described hereinafter. Identifying information 27 may preferably take the form of data in, for instance, about 10 digits. Also, identifying information may further include a numeral, an alphabet and a symbol, etc. In such configuration, an improved security is obtained while taking convenience of inputting operation into consideration. Also, the identifying information 27 may take a form that has the alphabets and numerals printed on the business card 25 as shown in FIG. 1 and may take another alternative way in which identifying information 27 is stored in an IC chip prepared on the business card 25, or identifying information 27 is shown using a barcode printed on the business card 25.

The server computer 9 is comprised of an interface 29 that allows transmission and reception of computer data, business card information database 31 that preserves business card information 20 delivered from the business card user computer 5, an identifying information memory 33 that stores identifying information 27 displayed over the business card 25 transmitted from the user computer 13, a business card information retrieving section 35 that retrieves business card information 20, in compliance with identifying information 27 displayed over the business card, from business card information database 31 by referring to identifying information 27 displayed over the business card 25, a business card memory 37 that temporarily stores retrieved business card information 20 to be transmitted to the user computer 13, a publication information preparing section 39 that prepares, for instance, a roll of a company by referring to business card information 20 stored in business card database 31, a publication information memory 41 that stores data such as the prepared roll of the company, and an identifying information preparing section 43 that prepares respective identifying information 27 with respect to business card information 20 transmitted from the business card computer 5.

Business card information 20 that is received with the server computer 9 set forth above includes only information, among information stored in business card user information database 23 of the business card user computer 5, that is authorized by the business card user 3. Namely, the business card user 3 may be configured to be set such that the name of the company among, for instance, business card information 20 is authorized to be available for reading with no authorization for a display of the family make-up.

In the meantime, an out-sourcing center 45 acts as the server computer 9 to perform the same operation as that of the server computer 9. This results in reduction in labor of a server management staff 7.

The user computer 13 is comprised of an input and output section 49 for inputting identifying information 27, displayed on the business card 25, through a display unit 47, an identifying information memory 51 that stores identifying information 27 displayed on the business card 25 which is inputted, an interface 53 that achieves transmission and reception of computer data (such as business card information 20 and identifying information 27, etc.), a business card information memory 55 that stores business card information 20 to be downloaded from the server computer 9 responsive to identifying information 27 displayed on the business card 25, and a business card information management section 57 that implements management (for instance, to be provided over the display unit 47) of stored business card information 20. Such operations can be performed with business card management software that is installed in the user computer 13. Also, connected to the computer 13 is an input and output device 59. The input and output device 59 includes a printer 61, a telephone TEL 63 and a facsimile FAX 65.

In the meantime, if business card information 20 stored in database 31 of the server computer 9 is updated, business card information 20 stored in the above-described business card information memory 55 is automatically downloaded to the business card information memory 55 of the user computer 13. This enables the user 11 to regularly read the newest business card information with a range that is authorized by the business card user 3.

Further, the business card information management system 1 includes an intervening company (inclusive of a business card printing company and a publisher, etc.) 4 that transmits business card information 20 to the server computer 9, and an intervening company computer (inclusive of a business card printing company computer and a publisher computer) 6 installed in the intervening company 4. With such configuration, if, for instance, the business card 25 is ordered to the business card printing company (the intervening company 4), business card information 20 is transmitted from the computer (the intervening computer 6) of the business card printing company to the server computer 9 for thereby enabling the business card 25 displayed with identifying information 27 to be prepared.

In a case where the intervening company 4 includes a publishing company, the server computer 9 is able to receive all of or a portion of business card information 20 from the business card user computer 5 via the publishing company. However, in such a case, business card information 20 does not necessarily need to be delivered through the network 15 as set forth above, but may be delivered through other medium.

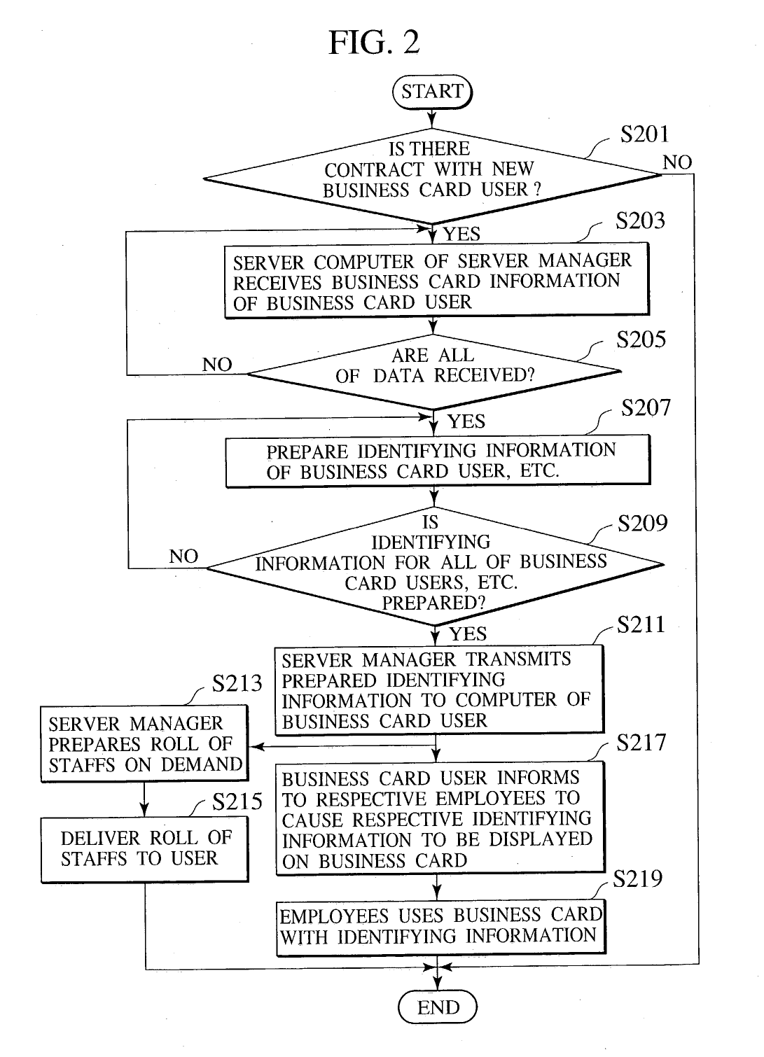

Now, the basic sequence of operations of the business card information management system 1 with the structure set forth above is described in greater detail with reference to FIGS. 2 to 5. FIG. 2 shows the sequential operations of the server computer 9 and the business card user computer 5.

In step S201, discrimination is made to find out whether a contract related to information management exists between the business card user 3 who newly participates to the present system 1 and the server management party 7. In the absence of the contract related to information management using the present system 1, the operation is terminated. In contrast, in the presence of the contract related to information management, the flow is routed to step S203.

In step S203, the server computer 9 of the server management party 7 receives business card information (such as the name of the company, the address, the division or section, the title, the number of TEL, the number of FAX and E-mail address, etc.) of the individual who belongs to the business card user (for instance, the company or the like) 3 via the interface 29. This business card information is stored in business card information database 31.

In step S205, discrimination is made to find out whether all data (forming business card information 20) is received. If all data (forming business card information 20) is not received, the flow is routed back to step S203 to continue the operation until all data is received. If it is discriminated that all data (forming business card information 20) is received, then the flow is routed to step S207.

In step S207, received identifying information 27 of each of individuals belonging to the business card user 3 (such as the company etc.) 3 is prepared with the identifying information preparing section 43.

In step S209, discrimination is made to find out whether identifying information 27 of all of the individuals belonging to the business card user (such as the company, etc) 3 is prepared. If all of data (business card information 20) is not prepared, the flow is routed back to step S207 to continue the operation until all of identifying information is prepared. When all of data (business card information 20) is prepared, the flow is routed to step S211.

In step S211, the server management party 7 transmits identifying information 27 to the enterpriser computer (the business card user computer) 5 via the server computer 9.

In step S213 and step 215, the roll of the company is prepared by-referring to business card information 20 stored in business card information database 31. Also, these steps are executed with the publication preparing section 39 set forth above.

In step S215, the resulting roll of the company is delivered to the user computer 13 on demand of the user 11.

In step S217, identifying information 27 received with the business card user computer 5 is displayed over the business card 25 of each of the individuals (such as employees and executives). As such, identifying information 27 is displayed on the business card 25 of the individual.

In step S219, the individual business card user 3 uses the business card 25 displayed with identifying information 27. As a result, the user 11 who received the business card 25 is enabled to manage business card information 20 based on identifying information 27 displayed on the business card 25.

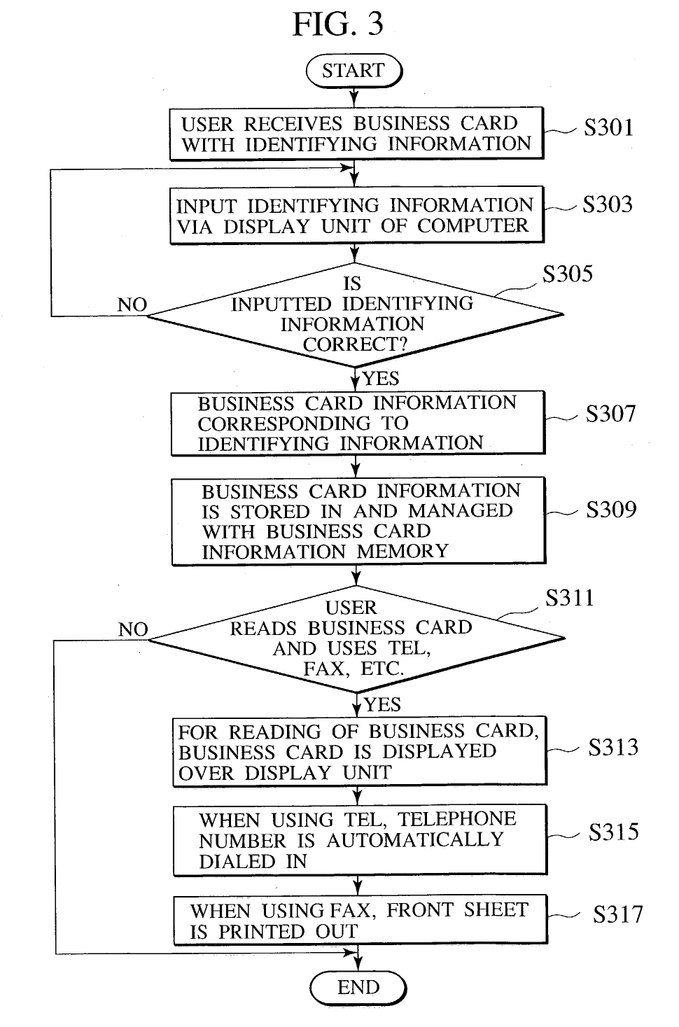

FIG. 3 shows the basic sequence of operations of the user computer 13.

In step S301, the user 11 receives the business card 25 displayed with identifying information 27.

In step S303, the user 11 operates the input and output section 49 to input identifying information 27 displayed on the business card 25 by means of the display unit 47 of the user computer 13.

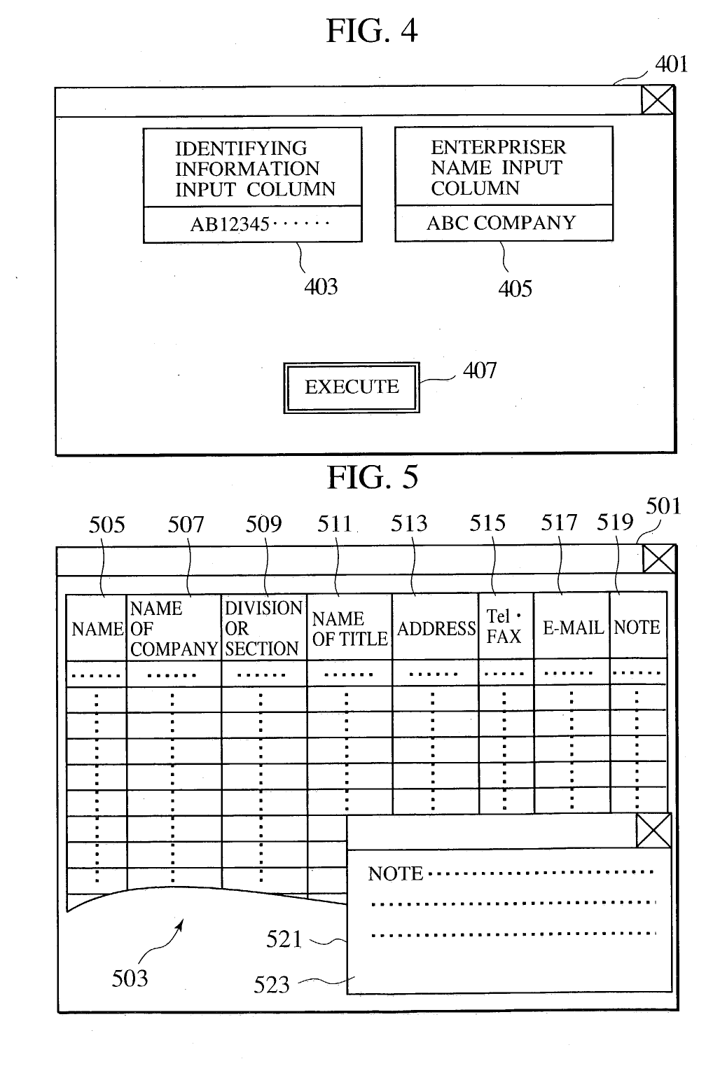

FIG. 4 show a screen to enable the user 11 to input identifying information 27 displayed on the business card 25. This screen 401 is displayed upon execution of business card management software (with the business card management section 57, etc.) preliminarily installed in the user computer 13. The screen 401 includes an identifying information input column 403, an input column for the enterpriser and an execution button 407. That is, the user 11 having received the business card 25 inputs identifying information 27, displayed on the business card 25, into the identifying information input column 403 and clicks the execution button 407. As a result, business card information 20 corresponding to identifying information 27 is downloaded to the user computer 13 from the server computer 9. That is, merely inputting identifying information 27 displayed on the business card 25 allows business card information 20 of respective individuals to be obtained.

Further, here, when inputting the name of the enterpriser into the enterpriser name input column 405 and clicking the execution button 407, the roll of the inputted enterpriser (such as the company, etc) is stored.

In step S305, discrimination is made to find whether inputted identifying information 27 displayed on the business card 25 is correct. If it is discriminated that inputted identifying information 27 displayed on the business card 25 is correct, the flow proceeds to step S307. If it is discriminated that inputted identifying information 27 displayed on the business card 25 is not correct, the flow is routed back to step S303. The system 1 is arranged to have a function such that in the absence of correct identifying information 27 even when, for instance, executing input operation is implemented a number of times in order to prevent an injustice, the operation is rendered inoperative.

In step S307, business card information 20 corresponding to identifying information 27 displayed on the business card 25 is delivered from the server computer 9, and the user computer 13 receives this business card information 20.

In step S309, business card information 20 is stored in business card memory 55.

In step S311, the user 11 discriminates whether to utilize a business card reading function and a linking function (including a function to use the telephone and FAX by means of the system 1) associated with TEL/FAX, etc. When utilizing these services with the use of the system 1, the flow is routed to step S313. If not, the flow is terminated.

In step S313, when the user reads the business card 25, business card information 20 is displayed over the display unit 47. As previously described, business card information 20 available to be read by the user 11 has a content that is preliminarily set by the business card user 5 to be available for reading.

FIG. 5 shows a screen 501 on which business card information 20 of the individuals is displayed. A table 503 displayed on the screen 501 involves an item 505 of a name, an item 507 of company name, an item 509 of a division or section, an item 511 of a title name, an item 513 of an address, an item 515 of TEL/FAX numbers, an item 517 of an E-mail address, and an item of a note. Here, for instance, when clicking the item 519 of the note for each individual, a note input screen 521 appears to be displayed. Upon operation of the user 11 to input a note content 523 via the note input screen 521, the content is stored in correlation with business card information. This results in a capability of increasing a volume of accompanying information related to the individual.

In step S315, clicking the telephone number displayed on the display column of the individual associated with the item 515 of TEL/FAX allows the telephone to be connected.

In step S317, during execution of FAX communication; for instance, a front sheet or the like of FAX is printed out from a printer 61. That is, when clicking the displayed FAX number, a FAX sheet described with the address, etc. is printed out from the printer 61.

While the present invention has been shown and described in connection with various services associated with one another as set forth above, it is conceivable for the present invention to involve other services such as, for instance, a service for printing (for instance, implementing a print on a mail using a printing machine) address information (an address, a name of a company, a division/section, a name, etc.).

Also, it is to be understood that the present invention is not limited to the embodiment set forth above and may take an appropriate alternation to carry out the present invention in an alternative embodiment.

As will be appreciated from the foregoing, the present invention concerns to an advantage in that the presence of only an input of preliminarily set identifying information enables management of business card information to be performed on the terminal of the system 1.

Upon realization of the above technology with an accompanying spread, the present invention has an advantage to provide a capability of providing associated services (for instance, a service for preparing a roll of the company, and a service to automatically starting up TEL, FAX and E-mail).

Further, business card information is transmitted to the server computer via the business card printing company, resulting in an advantage of an increase in a convenience for the business card user.

As previously described above, it is supposed that the business card user 3 may include, in addition to the party such as the company, an individual user. The use of the structure of the business card information management system 1 enables an individual person to utilize this system such that if the individual users, using the present systems, have respective business cards to exchange these cards, it is possible to achieve information exchange and arrangement adapted to the times of Internet as well as convenience in utilizing such information.

The entire content of Japanese Patent Application No. P2002-168675 with a filing date of Jun. 10, 2002 is herein incorporated by reference. Although the invention has been described above by reference to certain embodiments of the present invention, the invention is not limited to the embodiments described above and changes will occur to those skilled in the art, in light of the teachings. The scope of the invention is defined with reference to the following claims.

What is claimed is:

1. A business card information management system for managing business card information using identifying information incidental to each business card, comprising:
a business card user computer including preparing means for preparing the business card information and transmitting means for transmitting prepared business card information;
a server computer including receiving means for receiving the business card information from the business card user computer, identifying information preparing means for preparing identifying information different for each received business card information, storing means for storing the identifying information in compliance with the business card information, transmitting means for transmitting the identifying information to the business card user computer, business card information storage means for storing business card information, and retrieving means for retrieving business card information, corresponding to the identifying information, from the storage means; and
a user computer available to communicate at least the identifying information and the business card information via the server computer and a network;
wherein when the user computer transmits the identifying information to the server computer via the network, the retrieving means transmits business card information, corresponding to the identifying information, to the user computer while allowing transmitted business card information to be displayed over display means of the user computer.

2. The business card information management system of claim 1, wherein the user computer includes interlocking means for enabling execution of a function interlocking with the business card information.

3. The business card information management system of claim 2, wherein the interlocking means is interlocked with printing means for printing a content of the business card information.

4. The business card information management system of claim 2, wherein the interlocking means is interlocked with means for dialing a telephone number stored in the business card information.

5. The business card information management system of claim 2, wherein the interlocking means is interlocked with a function to transmit an electronic mail to an electronic mail address stored in the business card information.

6. The business card information management system of claim 1, wherein the receiving means receives at least a portion of the business card information via a publishing company.

7. The business card information management system of claim 1, wherein the server computer includes publication information preparing means for extracting given information among information in the business card information storage means, and publication information storing means for storing extracted information.

8. The business card information management system of claim 1, wherein the server computer includes means for receiving the business card information via a business card publishing company.

9. A business card information management server that manages identifying information of a business card and business card information and is available to comply with response of a computer to be accessed, comprising:
transmitting and receiving means for transmitting and receiving business card information;
identifying information preparing means for preparing identifying information different for each of the business card information;
identifying information storing means for storing the identifying information;
business card information storage means for storing the business card information; and
retrieving means for retrieving the business card information, corresponding to the identifying information, from the identifying information;
wherein the retrieved business card information is transmitted to the computer to be accessed via the transmitting receiving means.

10. A business card information acquiring device that acquires business card information, using identifying information incidental to a business card, from a storage device that stores business card information, comprising:
an input section for allowing the identifying information to be inputted;
a storing means for storing inputted identifying information;
transmitting means for transmitting identifying information, stored in the storing means, to the storage device;
receiving means for receiving business card information transmitted from the storage device; and
display means for providing a display of received business card information.

11. The business card information management system of claim 1, wherein:
the business card user computer has a function to arbitrarily restrict the content of business card information available with the user computer; and
information available with the user computer includes business card information that is preliminarily authorized with the business card user computer.
